(19) United States
(12) Patent Application Publication
(10) Pub. No.: US 2005/0157588 A1
(43) Pub. Date: Jul. 21, 2005

(54) Device at a mixing container for preparation of bone cement

(76) Inventor: Sören Jonsson, Linkoping (SE)

Correspondence Address: HARNESS, DICKEY & PIERCE, P.L.C., P.O. BOX 8910, RESTON, VA, 20195, US

(21) Appl. No.: 10/511,716

(22) PCT Filed: Dec. 2, 2002
(86) PCT No.: PCT/SE02/02208

(30) Foreign Application Priority Data
Apr. 18, 2002 (SE) 0201180-7

(51) Int. Cl. B01F 13/06; B01F 7/20

(52) U.S. Cl. 366/139; 366/252

(57) ABSTRACT

The invention relates to a device in a mixing vessel (1) intended for the preparation of bone cement and comprising a mixing bowl (3) provided with tightly sealing lid (2). Rotatably supported in the lid (2) is at least one mixing element (4, 4′, 4″), which is designed to sweep over substantially the whole internal chamber of the mixing bowl (3) in order to carefully mix the two constituents of the bone cement with one another. There is, furthermore, a connection to a vacuum source in order to create a vacuum in the chamber of the bowl (3) in connection with the preparation. One of the constituents of the bone cement may be situated in the internal chamber prior to preparation and the other may be delivered to the said chamber via an aperture in the lid (2) by means of the vacuum prevailing in the internal chamber. The device further comprises a drive member operatively connected to the mixing element.

The present invention relates to a device according to the pre-characterising clause of claim 1.

As examples of the prior art, reference will be made to U.S. Pat. Nos. 4,185,072, 4,961,647, 5,494,349 and 5,549,381 and to EP 1 068 893 A2.

In the preparation of bone cement it is extremely important that the two constituents of the cement are well mixed, since this substantially affects the strength of the cement. This means, among other things that every effort should be made to prevent a monotonic mixing process. In the aforementioned examples of the prior art, the drive member operatively connected to the mixing element comprises a manually operatable crank handle. With a drive member in such a form, the possibility cannot be ruled out that the person undertaking the preparation, for reasons of convenience or other reasons, will turn the crank handle round in one direction, which means that the mixing element sweeps over the mixing bowl in one single direction of rotation.

The object of the present invention is to prevent such a monotonic mixing process and this is achieved in that the invention has the features specified in the characterising part of claim 1.

The invention will be explained in more detail below with reference to the drawing attached, in which

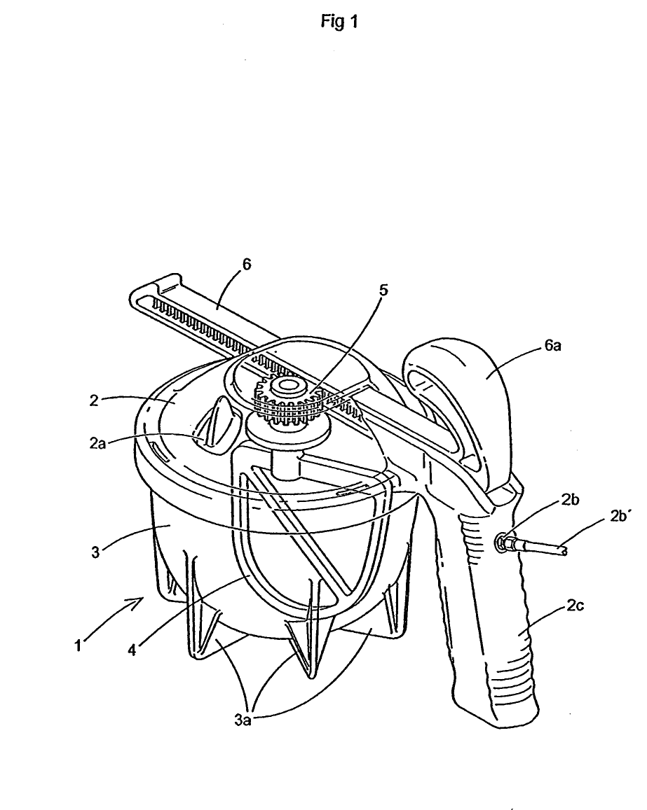

FIG. 1 shows a perspective view of one embodiment of a mixing vessel according to the invention.

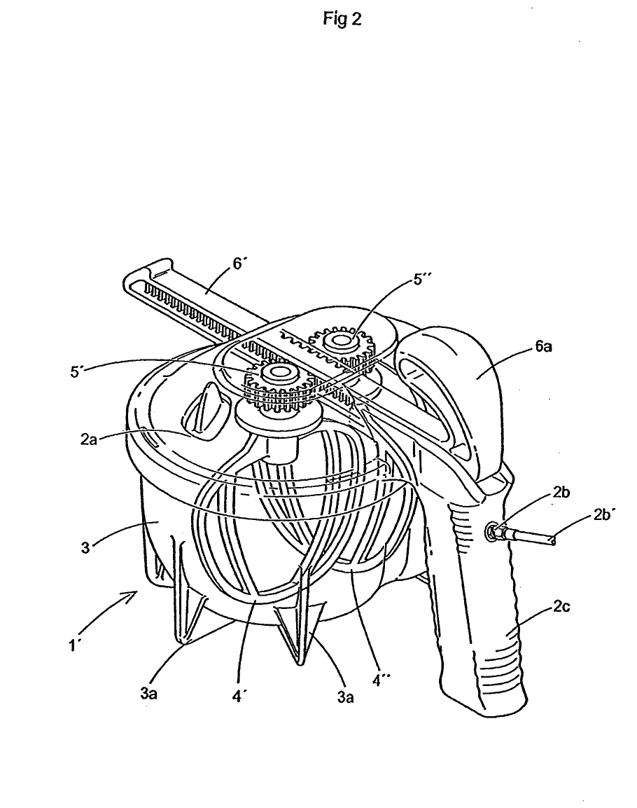

FIG. 2 shows a corresponding view of a mixing vessel having two sub-chambers and mixing elements designed to sweep over the said sub-chambers.

In the drawing, 1 generally denotes a mixing vessel intended when in use to be placed on a flat surface, such as a work-table. The mixing vessel comprises a mixing bowl 3 provided with a tightly sealing lid 2. It is intended that the user should grip the lid 2, which is provided with a handle 2c, with one hand when preparing bone cement. In order to achieve good stability, the handle 2c is designed so that in use its remote end rests on the underlying work surface. There are also leg-like supports 3a, intended for the same purpose, projecting radially from the mixing bowl 3.

Rotatably supported in the lid 2 of the mixing vessel 1 is a mixing element 4 designed to sweep over substantially the whole internal chamber of the mixing bowl 3 for the purpose of mixing the two constituents of the bone cement with one another.

One constituent is a polymer in powder form, with which the mixing vessel may be suitably pre-filled, and the other is a liquid monomer, which is delivered to the mixing vessel by way of a sealable aperture 2a in the lid.

Mixing of the bone cement constituents is done under vacuum, partly in order to prevent porous inclusions in the bone cement, and partly in order to prevent noxious gases escaping from the mixing vessel. For this purpose the handle 2c contains a connection aperture 2b, communicating with the interior of the mixing vessel 3, for a vacuum hose 2b′.

The introduction of one or both of the constituents of the bone cement is preferably achieved by means of the vacuum prevailing in the internal chamber of the mixing bowl 3.

In order to enable the mixing element 4, rotatably supported in the lid 2, to perform a rotational movement, the direction of which reliably changes in accordance with a predefined pattern, a toothed gear 5, which meshes with a rack 6, which is displaceably supported in the lid 2 and has a handle 6a, by means of which the rack 6 can be manually displaced forwards and backwards in its longitudinal direction, is connected to the mixing element 4, the mixing element 4 being compelled to perform corresponding rotational movements in opposing directions. In this way an efficient mixing of the bone cement constituents is achieved.

The embodiment according to FIG. 2 differs from the embodiment explained above with reference to FIG. 1 in that the internal chamber of the mixing bowl 3 comprises two sub chambers each having a mixing element 4′ and 4″ respectively, which are rotatably supported in the lid 2 and each have their own toothed gear 5′ and 5″ respectively meshing with the rack 6′. The latter is provided with teeth on opposite sides.

Since the mixing elements 4′, 4″ sweep over a common internal chamber, synchronisation of the mixing elements is required so that these do not collide and catch in one another. Such synchronisation is achieved by the toothed gears 5′, 5″ meshing with the rack 6′. With the two mixing elements 4′, 4″ it is possible to achieve an improved mixing result.

1. Device in a mixing vessel intended for the preparation of bone cement and comprising a mixing bowl provided with tightly sealing lids, at least one mixing element which is rotatably supported in the lid 2 and is designed to sweep over substantially the whole internal chamber of the mixing bowl in order to carefully mix the two constituents of the bone cement with one another, a connection to a vacuum source in order to create a vacuum in the chamber of the bowl in connection with the preparation, one of which constituents may be situated in the internal chamber prior to preparation and the other of which may be delivered to the said chamber via an aperture in the lid by means of the vacuum prevailing in the internal chamber, the device comprising a drive member operatively connected to the mixing element, wherein the said drive member comprises a toothed gear which is operatively connected to each mixing element and meshes with a corresponding rack, which is supported so that it can slide in the lid and is provided with an operating handle.

2. Device according to claim 1, wherein the internal chamber of the mixing bowl comprises two sub-chambers, which are open to one another and are each designed to be swept over by a mixing element, which with an associated toothed gear meshes with opposing teeth on the rack.
